(19) United States
(12) Patent Application Publication
(10) Pub. No.: US 2013/0266923 A1
(43) Pub. Date: Oct. 10, 2013

(54) Interactive Multimedia Instructional System and Device

(71) Applicant: Kuo-Yuan Lee, Taipei City (TW)

(72) Inventor: Kuo-Yuan Lee, Taipei City (TW)

(21) Appl. No.: 13/442,872

(22) Filed: Apr. 10, 2012

(51) Int. Cl. G09B 5/00

(52) U.S. Cl. 434/351

(57) ABSTRACT

An interactive multimedia instructional system and device include a wireless guidance unit used by an instructor and plural wireless interaction units used by pupils. The wireless guidance unit and the wireless interaction units are connected wirelessly with a computer host loaded with a multisite and point-and-click operating system and instructional software. A display unit is connected with the computer host to display execution pictures of the instructional software and to display pointers by the wireless guidance unit and the wireless interaction units. The instructional software includes a group management program and a lesson plan editing interface on the display unit. As a result, one-to-many interactive multimedia teaching that is more enriched, vivid and effective can be achieved through this electronic instructional system, between the instructor and the pupils.

### BACKGROUND OF THE INVENTION

a) Field of the Invention

The present invention relates to an interactive multimedia instructional system and device, allowing one-to-many interactive teaching to be achieved between an instructor and pupils through a wireless guidance unit and plural wireless interaction units.

b) Description of the Prior Art

An ordinary electronic instructional system or device uses primarily at least one display to show contents of teaching to an instructor, allowing pupils to watch operations that are demonstrated or pictures that are played by the instructor, through a projector or plural connected computer screens.

However, the conventional electronic instructional system or device is only used for one-way teaching. Although the contents of teaching can be demonstrated to the pupils, the conventional electronic instructional system will not be able to assist or can only maintain one-to-one interaction when the pupils have questions to ask or when interactive teaching is required.

As a result, the present inventor has studied and researched the electronic instructional system or device, thereby designing an interactive multimedia instructional system and device to achieve one-to-many interactive teaching that is more enriched, vivid and effective, between the instructor and the pupils.

### SUMMARY OF THE INVENTION

The primary object of the present invention is to provide an interactive multimedia instructional system, allowing one instructor to carry out interactive teaching that is enriched, vivid and effective, with plural pupils simultaneously. To achieve the abovementioned object, the interactive multimedia instructional system of the present invention includes a computer host which is loaded with a multisite and point-and-click operating system and instructional software; a wireless guidance unit which is provided with a first processing unit that communicates to the computer host with wireless guidance signals, a first microphone that is connected with the first processing unit, a first wireless operating interface that is connected with the first processing unit and a first power device that is connected with the first processing unit; plural wireless interaction units, each of which is provided with a second processing unit that communicates to the computer host with wireless interaction signals, a second microphone that is connected with the second processing unit, a second wireless operating interface that is connected with the second processing unit and a second power device that is connected with the second processing unit; and at least one display unit that is connected with the computer host to display execution pictures of the instructional software and to display a pointer when the abovementioned wireless guidance unit collimates a wireless interaction unit.

Accordingly, the instructor and the pupils can perform interactive teaching through operation of the wireless guidance unit and the wireless interaction units and can store and record messages received by the first microphone and the second microphones through the computer host.

The said computer host is connected with an audio unit to play the messages received by the abovementioned first microphone and second microphones.

The said computer host is connected with at least a wired operating interface, such as a keyboard or a mouse.

The said computer host is connected with an image capture unit, such as a digital camera or a video lens.

The said first wireless operating interface includes an interaction unit on-off switch key, a first microphone on-off switch key, a pointer point-and-click press key and a pointer hand writing key, such that when the instructor presses the interaction unit on-off switch key, the on-off of each interaction unit can be switched; when the first microphone on-off switch key is pressed, the first microphone can be turned on or off; when the pointer point-and-click press key is pressed, the pointer can be moved around, pointed and clicked like a mouse; or when the pointer hand writing key is pressed, a writing effect can be manifested on the display unit by moving the wireless guidance unit like a mouse-pen.

The said second wireless operating interface includes a first-answer key, a second microphone on-off switch key, a pointer point-and-click press key and a pointer hand writing key, such that when a pupil presses the first-answer key, the question for the first-answer can be displayed; when the second microphone on-off switch key is pressed, the second microphone can be turned on or off; when the pointer point-and-click press key is pressed, the pointer can be moved around, pointed and clicked like a mouse; or when the pointer hand writing key is pressed, a writing effect can be manifested on the display unit by moving the wireless interaction unit like a mouse-pen.

The said second wireless operating interface is further provided with plural game operation keys, allowing the pupils to operate the game-type instructional software through the game operation keys.

The said wireless interaction unit is further provided with a built-in voice recording and playing unit, allowing a pupil to store messages of the first microphone or the second microphone and then to play them.

The said wireless interaction unit is further loaded with identification information, allowing the computer host to verify identity of the wireless interaction unit.

The instructional software that is loaded into the computer host includes a group management program to conduct group competition and scoring, merit and demerit recording, as well as classroom management.

The instructional software that is loaded into the computer host can execute a user headshot cursor program to manifest a user's identification of each wireless interaction unit and to shoot and build up headshots of students by the image capture unit. The instructional software can store and record pictures of the user headshot cursors of groups in a class, allowing the users to feed in directly for a next session. Each user is provided with a reference code and the user identity can be verified by inputting the reference code. Besides, a same wireless interaction unit can provide for use by plural users and the instructional software can store and record interaction records of the wireless interaction units that are used by the users.

The instructional software that is loaded into the computer host includes a lesson plan editing program to display a lesson editing interface on the display unit, allowing for inserting and removing a multimedia lesson plan application program and text input. An editor can edit and modify a lesson plan directly on the display unit through the wireless guidance unit.

Another object of the present invention is to provide an interactive multimedia instructional device, allowing one instructor to carry out interactive teaching that is enriched, vivid and effective, with plural pupils simultaneously. To achieve the abovementioned object, the interactive multimedia instructional device of the present invention communicates wirelessly with a computer host which is loaded with a multisite and point-and-click operating system and instructional software. The interactive multimedia instructional device includes a wireless guidance unit which is provided with a first processing unit that communicates to the computer host with wireless guidance signals, a first microphone that is connected with the first processing unit, a first wireless operating interface that is connected with the first processing unit and a first power device that is connected with the first processing unit; and plural wireless interaction units, each of which is provided with a second processing unit that communicates to the computer host with wireless interaction signals, a second microphone that is connected with the second processing unit, a second wireless operating interface that is connected with the second processing unit and a second power device that is connected with the second processing unit.

The said first wireless operating interface includes an interaction unit on-off switch key, a first microphone on-off switch key, a pointer point-and-click press key and a pointer hand writing key, such that when the instructor presses the interaction unit on-off switch key, the on-off of each interaction unit can be switched; when the first microphone on-off switch key is pressed, the first microphone can be turned on or off; when the pointer point-and-click press key is pressed, the pointer can be moved around, pointed and clicked like a mouse; or when the pointer hand writing key is pressed, a writing effect can be manifested on the display unit by moving the wireless guidance unit like a mouse-pen.

The said second wireless operating interface includes a first-answer key, a second microphone on-off switch key, a pointer point-and-click press key and a pointer hand writing key, such that when a pupil presses the first-answer key, the question for the first-answer can be displayed; when the second microphone on-off switch key is pressed, the second microphone can be turned on or off; when the pointer point-and-click press key is pressed, the pointer can be moved around, pointed and clicked like a mouse; or when the pointer hand writing key is pressed, a writing effect can be manifested on the display unit by moving the wireless interaction unit like a mouse-pen.

The said second wireless operating interface is further provided with plural game operation keys, allowing the pupils to operate the game-type instructional software through the game operation keys.

The said wireless interaction unit is further provided with a built-in voice recording and playing unit, allowing a pupil to store messages of the first microphone or the second microphone and then to play them.

The said wireless interaction unit is further loaded with identification information, allowing the computer host to verify identity of the wireless interaction unit.

In comparison to a conventional instructional system and device, the advantages of the present invention lie in that the one-to-many simultaneous interactive teaching can be developed and plural pointers of operation can be displayed on the display unit at a same time, in collaboration with the implementation of a multisite and point-and-click operating system (e.g., WINDOWS 7 or other multisite and touch-control or point-and-click operating systems), allowing the interactive teaching to be more enriched, vivid and effective. In addition, the said computer host, wireless guidance unit and wireless interaction units utilize infrared to transmit positioning signals and Bluetooth to transmit motion signals with the effective range of emission and receiving reaching 20˜50 m, such that the interactive teaching can be more convenient.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an interactive multimedia instructional system of the present invention.

FIG. 2 shows a schematic view of components of a wireless guidance unit of the present invention.

FIG. 3 shows a schematic view of appearance of the wireless guidance unit of the present invention.

FIG. 4 shows a schematic view of components of a wireless interaction unit of the present invention.

FIG. 5 shows a schematic view of appearance of the wireless interaction unit of the present invention.

FIG. 6 shows a a functional architecture diagram of instructional software of the present invention.

### DETAILED DESCRIPTION OF THE PREFERRED EMBODIMENTS

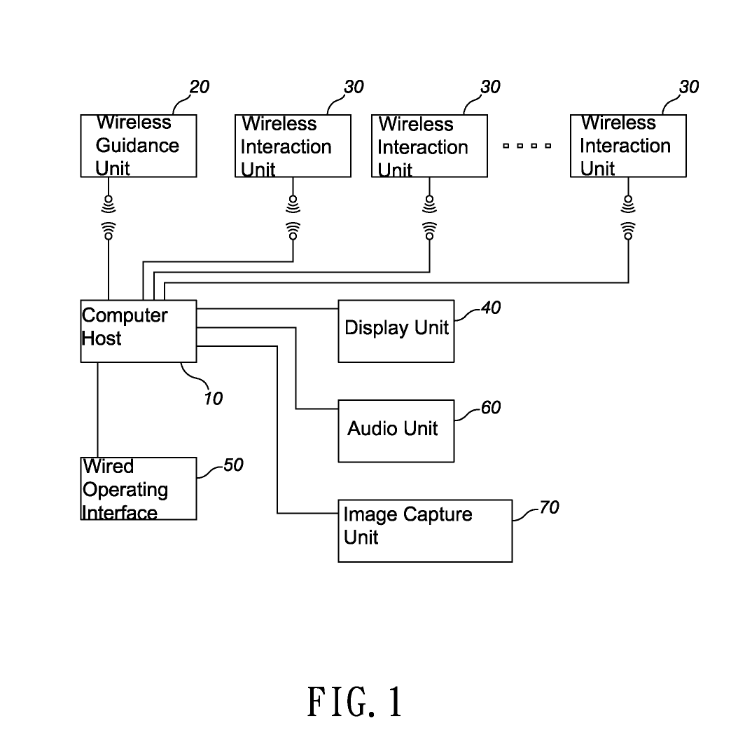

Referring to FIGS. 1, 2 and 4, it shows a schematic view of an interactive multimedia instructional system of the present invention, including a computer host 10, a wireless guidance unit 20, plural wireless interaction units 30, a display unit 40, at least a wired operating interface 50, an audio unit 60 and an image capture unit 70.

The computer host 10 is loaded with a multisite and point-and-click operating system (such as WINDOWS 7, other multisite and touch-control or point-and-click operating systems, or even independent operating systems) and can emit, receive and process messages (signals) transmitted by the wireless guidance unit 20 and the wireless interaction units 30, with a range of emission and receiving preferably reaching 20˜50 m. The computer host 10 is provided with an interactive function of receiving multisite control simultaneously, so as to correspond to related operations of multisite pointers resulted from the wireless guidance unit 20 and the wireless interaction units 30.

The display unit 40 can be a projector or plural connected computer screens to display signals outputted by the computer host 10, allowing the pupils to watch and perform interactive operations.

The computer host 10 can be also operated through the wired operating interface 50, such as connection to a keyboard or mouse or both at a same time. The audio unit 60 is used to play messages received by a first microphone 22 and second microphones 32 or audio signals that are outputted by the computer host 10 when running the operating system or instructional software. The image capture unit 70 is used to capture digital images for teaching aid and can be implemented as a digital camera or a video lens.

The wireless guidance unit 20 and the wireless interaction units 30 are the interactive multimedia instructional devices of the present invention. The wireless guidance unit 20 and the wireless interaction units 30 can intercommunicate with the computer host 10 through signals that comply to a communication protocol, such as the infrared signals or the Bluetooth signals, wherein the infrared signal is used primarily for transmission of positioning signals among the computer host 10, the wireless guidance unit 20 and the wireless interaction units 30; whereas, the Bluetooth signal is used for transmission of motion signals among the computer host 10, the wireless guidance unit 20 and the wireless interaction units 30.

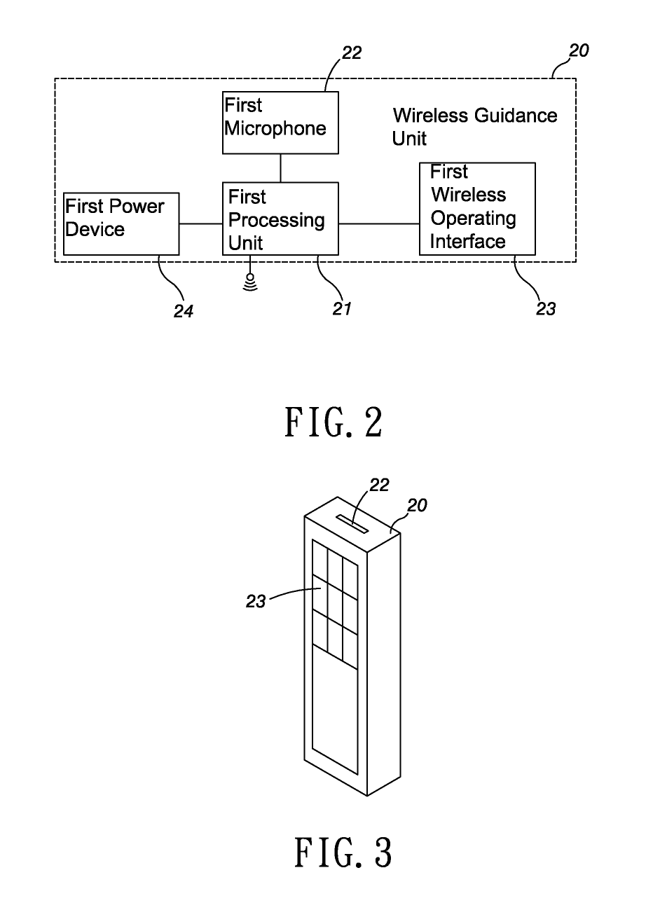

Referring to FIG. 2 and FIG. 3, it shows a schematic view of components and a schematic view of appearance of the wireless guidance unit of the present invention. The wireless guidance unit 20 is used primarily by the instructor and is provided with a first processing unit 21 that transmits wireless guidance signals to the computer host 10 (referring to FIG. 1), the first microphone 22 that is connected with the first processing unit 21, a first wireless operating interface 23 that is connected with the first processing unit 21 and a first power device 24 that is connected with the first processing unit 21.

The said first wireless operating interface 23 is provided with at least an interaction unit on-off switch key, a first microphone on-off switch key, a pointer point-and-click press key and a pointer hand-writing key, such that when the instructor presses the interaction unit on-off switch key, the on-off of each interaction unit can be switched; when the first microphone on-off switch key is pressed, the first microphone 22 can be turned on or off; when the pointer point-and-click press key is pressed, the pointer can be moved around, pointed and clicked like a mouse; or when the pointer hand-writing key is pressed, a writing effect can be manifested on the display unit 40 by moving the wireless guidance unit 20 like a mouse pen. In addition to that the mouse pen-like operation includes writing in air, putting a check mark, putting a circle and putting a cross, the first wireless operating interface 23 is further provided with a hand writing pad (or a touch screen). Therefore, questions and supplementary contents that are found in a session can be quickly and accurately inputted by hand writing and texts that have been written down can be transmitted to the computer host 10, followed by being manifested in courses of a lessen plan on the display unit 40 and interacting with the pupils. Or, the contents of hand writing can be stored and recorded in the computer host 10 for teaching review and research or follow-up. The press-button type of the first wireless operating interface 23 as shown in FIG. 3 is only for exemplification and in a practical implementation, the first wireless operating interface 23 can be provided according to functional designs of the device and in collaboration with ergonomics to facilitate operation.

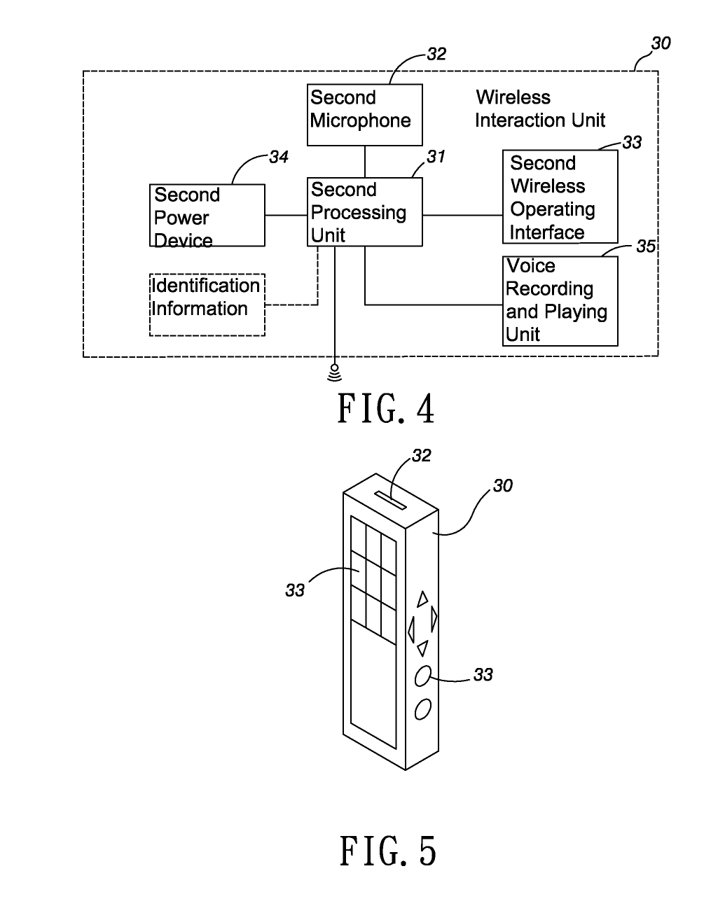

Referring to FIG. 4 and FIG. 5, it shows a schematic view of components and a schematic view of appearance of the wireless interaction unit of the present invention. The wireless interaction units 30 are used primarily by the pupils and each unit is provided with a second processing unit 31 that communicates to the computer host 10 with wireless interaction signals, the second microphone 32 that is connected with the second processing unit 31, a second wireless operating interface 33 that is connected with the second processing unit 31 and a second power device 34 that is connected with the second processing unit 31. Each wireless interaction unit 30 further includes a built-in voice recording and playing unit 35, such that the pupils are able to store messages of the first microphone 22 or the second microphones 32 and then to play them. Furthermore, each wireless interaction unit 30 is also loaded with identification information, allowing the computer host 10 to identify the wireless interaction unit 30.

The second wireless operating interface 33 is provided with at least a first-answer key, a second microphone on-off switch key, a pointer point-and-click press key and a pointer hand-writing key, such that when a pupil presses the first-answer key, the question for first-answer can be displayed; when the pointer point-and-click press key is pressed, the pointer can be moved around, pointed and clicked like a mouse; or when the pointer hand-writing key is pressed, a writing effect can be manifested on the display unit 40 by moving the wireless interaction unit 30 like a mouse pen. In addition to that the mouse pen-like operation includes writing in air, putting a check mark, putting a circle and putting a cross, the second wireless operating interface 33 is further provided with a hand writing pad (or a touch screen). Therefore, texts can be quickly and accurately written down and can be transmitted to the computer host 10, followed by being manifested in courses of a lessen plan on the display unit 40 and interacting with the instructor. The said second wireless operating interface 33 further includes plural game operation keys, allowing the pupils to operate the game-type instructional software. The press-button type of the second wireless operating interface 33 as shown in FIG. 5 is only for exemplification and in a practical implementation, the second wireless operating interface 33 can be provided according to functional designs of the device and in collaboration with ergonomics to facilitate operation.

Referring to FIG. 1, FIG. 2 and FIG. 4, in addition to being through the first wireless operating interface 23 and the second wireless operating interfaces 33, the interactive teaching can be conducted through the first microphone 22 and the second microphones 32. For example, when teaching English, pronunciation of a teacher can be broadcasted on the audio unit 60 that is connected externally to the computer host 10 to which the first microphone 22 of the wireless guidance unit 20 is connected; whereas, English pronunciation of a student can be broadcasted on the audio unit 60 that is connected externally to the computer host 10 to which the second microphone 22 of the wireless interaction unit 30 is connected, and can be stored and recorded in a data base in the computer host 10. Besides, the teacher can correct on-site a student's pronunciation with the wireless guidance unit 20 and record it in the computer host 10.

The present invention can be further used collaboratively with an implementation of a multimedia instructional software application program platform; for example, the present invention can be applied to a group management program (e.g., having a classroom management function such as group competition and scoring, merit and demerit recording, etc.) or a user (student) headshot cursor program to display the user identity of every wireless interaction unit 30, wherein the user headshot can be shot and built up by a camera device that is connected to the computer host. In the user headshot cursor program, plural users can even use one wireless interaction unit 30 at a same time and pictures of the user headshot cursors of groups in a class can be also stored and recorded to be fed in directly for a next session. Each user is provided with a reference code (e.g., a registration number) and the user identity is verified by inputting the reference code. As a result, when the users of various classes are attending a class, they can use a same wireless interaction unit 30 and a course interaction record of the wireless interaction unit 30 for students can be also stored and recorded, in order to carry out a multipurpose intellectual evaluation, for example. Moreover, a lesson plan editing interface can provide for inserting or removing a multimedia lesson plan application program and text input (similar to a PPT (PowerPoint) interface function). The wireless guidance unit 20 of an editor (teacher) can be combined with lesson plan editing; whereas, questions and supplementary contents that are found in a session can be transmitted to the computer host 10 through the wireless guidance unit 20.

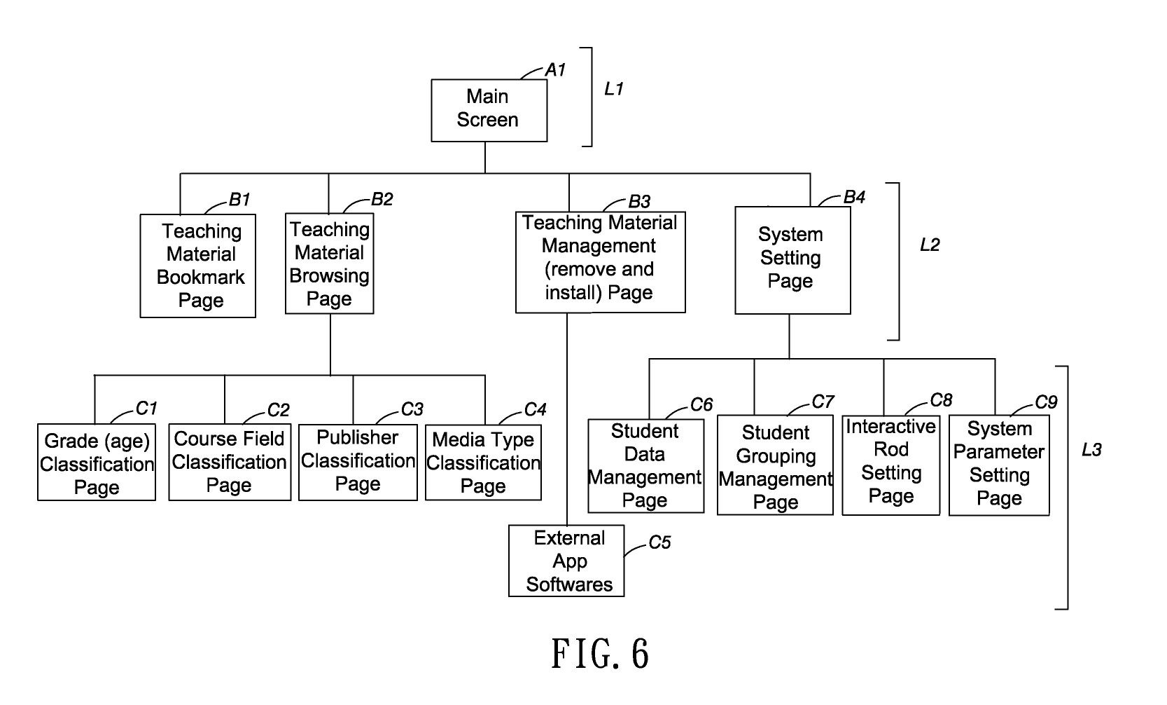

Referring to FIG. 6, it shows a functional architecture diagram of the instructional software of the present invention. Through the display unit 40 (as shown in FIG. 1), the instructional software can display a main screen A1 at a first layer of architecture L1. The main screen A1 is provided with four point-and-click windows of menus, allowing the user to point and click and then to enter respectively into four pages at a second layer of architecture L2. The four pages of the second layer of architecture L2 are a teaching material bookmark page B1, a teaching material browsing page B2, a teaching material management (remove and install) page B3, and a system setting page B4. The teaching material browsing page B2 is provided with four point-and-click windows of menus, in addition to the windows of returning to the main page and of returning to the previous page, allowing the user to point and click and then to enter respectively into four pages at a third layer of architecture L3. The abovementioned four pages are a grade (age) classification page C1, a course field classification page C2, a publisher classification page C3 and a media type classification page C4.

In addition to the windows of returning to the main page and of returning to the previous page, the teaching material management (remove and install) page B3 is provided with point-and-click windows that are shown up associated with external App softwares C5, allowing the user to point and click, and then to enter repectively into pages corresponding to the external App softwares at the third layer of architecture L3.

In addition to the windows of returning to the main page and of returning to the previous page, the system setting page B4 is provided with four point-and-click windows of menus, allowing the user to point and click and then to enter respectively into four pages at the third layer of architecture L3. These four pages are a student data management page C6, a student grouping management page C7, an interactive rod setting page C8 and a system parameter setting page C9.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An interactive multimedia instructional system comprising:
a computer host, wherein the computer host is loaded with a multisite and point-and-click operating system and instructional software;
a wireless guidance unit, the wireless guidance unit is provided with a first processing unit communicating to the computer host with wireless guidance signals, a first wireless operating interface connecting the first processing unit and a first power device connecting the first processing unit;
plural wireless interaction units, each wireless interaction unit is provided with a second processing unit communicating to the computer host with wireless interaction signals, a second wireless operating interface connecting the second processing unit and a second power device connecting the second processing unit; and
a display unit, wherein the display unit is connected with the computer host to display execution pictures of the instructional software and to display a pointer when the wireless guidance unit collimates the wireless interaction unit.

2. The interactive multimedia instructional system according to claim 1, wherein the wireless guidance unit further includes a first microphone connecting the first processing unit and each wireless interaction unit further includes a second microphone connecting the second processing unit.

3. The interactive multimedia instructional system according to claim 1, wherein the first wireless operating interface includes an interaction unit on-off switch key, a first microphone on-off switch key, a pointer point-and-click press key and a pointer hand-writing key.

4. The interactive multimedia instructional system according to claim 1, wherein the first wireless operating interface is provided with a hand writing pad or a touch screen.

5. The interactive multimedia instructional system according to claim 1, wherein the second wireless operating interface includes a first-answer key, a second microphone on-off switch key, a pointer point-and-click press key and a pointer hand writing key.

6. The interactive multimedia instructional system according to claim 5, wherein the second wireless operating interface is further provided with a hand writing pad or a touch screen.

7. The interactive multimedia instructional system according to claim 5, wherein the second wireless operating interface is provided with plural game operation keys.

8. The interactive multimedia instructional system according to claim 1, wherein each wireless interaction unit is further provided with a built-in voice recording and playing unit.

9. The interactive multimedia instructional system according to claim 1, wherein each wireless interaction unit is further loaded with identification information.

10. The interactive multimedia instructional system according to claim 1, wherein the instructional software that is loaded into the computer host includes a group management program to conduct group competition and scoring, merit and demerit recording, as well as classroom management.

11. The interactive multimedia instructional system according to claim 1, wherein the instructional software that is loaded into the computer host includes a user headshot cursor program to display the user of every wireless interaction unit, shoot and build up student headshots by an image capture unit, as well as store and record pictures of the user headshot cursors of groups in a class to be fed in directly for a next session, with that each user is provided with a reference code to verify the user identity, and the instructional software includes storing and recording interaction records of the wireless interaction units used by the users.

12. The interactive multimedia instructional system according to claim 1, wherein the instructional software that is loaded into the computer host includes a lesson plan editing program, with a lesson plan editing interface being displayed on the display unit to provide for inserting and removing a multimedia lesson plan application program and text input, and an editor directly editing and modifying the lesson plans on the display unit through the wireless guidance unit.

13. An interactive multimedia instructional device communicating to a computer host with wireless signals, the computer host being loaded with a multisite and point-and-click operating system and instructional software, and the interactive multimedia instructional device comprising:
a wireless guidance unit, the wireless guidance unit is provided with a first processing unit communicating to the computer host with wireless guidance signals, a first wireless operating interface connecting the first processing unit and a first power device connecting the first processing unit; and
plural wireless interaction units, each wireless interaction unit is provided with a second processing unit communicating to the computer host with wireless interaction signals, a second wireless operating interface connecting the second processing unit and a second power device connecting the second processing unit.

14. The interactive multimedia instructional device according to claim 13, wherein the wireless guidance unit further includes a first microphone connecting the first processing unit and each wireless interaction unit further includes a second microphone connecting the second processing unit.

15. The interactive multimedia instructional device according to claim 13, wherein the first wireless operating interface includes an interaction unit on-off switch key, a first microphone on-off switch key, a pointer point-and-click press key and a pointer hand writing key.

16. The interactive multimedia instructional device according to claim 13, wherein the first wireless operating interface is provided with a hand writing pad or a touch screen.

17. The interactive multimedia instructional device according to claim 13, wherein the second wireless operating interface includes a first-answer key, a second microphone on-off switch key, a pointer point-and-click press key and a pointer hand writing key.

18. The interactive multimedia instructional device according to claim 13, wherein the second wireless operating interface is provided with a hand writing pad or a touch screen.

19. The interactive multimedia instructional device according to claim 13, wherein the second wireless operating interface is further provided with plural game operation keys.

20. The interactive multimedia instructional device according to claim 13, wherein each wireless interaction unit is further provided with a built-in voice recording and playing unit.

21. The interactive multimedia instructional device according to claim 13, wherein each wireless interaction unit is further loaded with identification information.
